(19) United States
(12) Patent Application Publication
(10) Pub. No.: US 2025/0178783 A1
(43) Pub. Date: Jun. 5, 2025

(54) RACK-SHIPMENT SYSTEM

(71) Applicant: SCHNEIDER ELECTRIC IT CORPORATION, Foxboro, MA (US)

(72) Inventors: Jie Zhu, Shanghai (CN); Timothy M. Horstmann, O'Fallon, MO (US); HaoFeng Li, Shanghai (CN)

(21) Appl. No.: 18/966,473

(22) Filed: Dec. 3, 2024

Related U.S. Application Data
(60) Provisional application No. 63/605,610, filed on Dec. 4, 2023.

(51) Int. Cl. B65D 19/38; B65D 19/06; B65D 81/127

(52) U.S. Cl. CPC B65D 19/38; B65D 19/06; B65D 81/127; B65D 2519/00805

(57) ABSTRACT

A rack-shipment system includes a pallet, a ramp hingedly coupled to the pallet, a rack coupled to the ramp, and a handle coupled to the rack. The ramp, the rack, and the handle are configured to rotate relative to the pallet to an upright position. The rack-shipment system further may include a cover operably coupled to the pallet and the ramp to enclose the rack, a top foam panel disposed on a side of the rack, and a bottom foam panel disposed on an opposite side of the rack. A method of shipping a rack includes positioning the rack on the pallet; coupling the ramp to the rack, and enclosing the rack for shipment.

### CROSS-REFERENCE TO RELATED APPLICATION

This application claims the benefit under 35 U.S.C. § 119 of U.S. Provisional Patent Application Ser. No. 63/605,610, filed Dec. 4, 2023, and titled RACK-SHIPMENT SYSTEM, which is hereby incorporated herein by reference in its entirety for all purposes.

### BACKGROUND OF THE DISCLOSURE

### 1. Field of Disclosure

The present disclosure is directed to a rack-shipment system configured to package an IT equipment rack pre-installed with IT equipment.

### 2. Discussion of Related Art

Equipment racks, sometimes referred to as IT equipment racks, are often preinstalled with IT equipment, e.g., servers, prior to shipment to a customer. When shipped, it is preferred to lay the equipment rack horizontally on a pallet. A fully loaded equipment rack can weigh 150 pounds (lbs).

### SUMMARY OF THE DISCLOSURE

One aspect of the present disclosure is directed to a rack-shipment system comprising a pallet, a ramp hingedly coupled to the pallet, a rack coupled to the ramp, and a handle coupled to the rack. The ramp, the rack, and the handle are configured to rotate relative to the pallet to an upright position.

Embodiments of the rack-shipment system further may include a cover operably coupled to the pallet and the ramp to enclose the rack. The rack-shipment system further may include a top foam panel disposed on a side of the rack, with the top foam panel being configured to protect the rack. The rack-shipment system further may include a bottom foam panel disposed on a side of the rack, with the bottom foam panel being configured to protect the rack. The rack may be positioned horizontally on the pallet, with the ramp being coupled to a bottom of the rack. The ramp may be releasably secured to casters provided on the bottom of the rack. The ramp may be releasably secured to the bottom of the rack by at least one bracket. The rack-shipment system of claim 1, wherein the ramp includes at least one inclined surface to enable the rack to be removed from the ramp when the rack is in the upright position. The handle may be extendable from a stowed position to an extended position. The ramp may be hingedly coupled to the pallet by at least one hinge.

Another aspect of the present disclosure is directed to a method of shipping a rack. In one embodiment, the method comprises: positioning a rack on a pallet; coupling a ramp to the rack, the ramp being hingedly coupled to the pallet; and enclosing the rack for shipment.

Embodiments of the method further may include coupling a handle to the rack, with the handle being configured to rotate the rack and the ramp with respect to the pallet to an upright position. The handle may be extendable from a stowed position to an extended position. The ramp may include at least one inclined surface to enable the rack to be removed from the ramp when the rack is in the upright position. Enclosing the rack may include installing a cover configured to be operably coupled to the pallet and the ramp. The method further may include disposing at least one of a top foam panel on a first side of the rack and a bottom foam panel on a second side of the rack. The rack may be positioned horizontally on the pallet, with the ramp being coupled to a bottom of the rack. Coupling the ramp to the rack may include releasably securing the ramp to casters provided on the bottom of the rack. Coupling the ramp to the rack may include releasably securing the ramp to the bottom of the rack by at least one bracket. The ramp may be hingedly coupled to the pallet by at least one hinge.

Another aspect of the present disclosure is directed to a rack-shipment system comprising a pallet, a ramp hingedly coupled to the pallet, a rack coupled to the ramp, and a handle coupled to the rack. The ramp, the rack, and the handle are configured to rotate relative to the pallet to an upright position.

Embodiments of the rack-shipment system further may include a cover operably coupled to the pallet to enclose the rack. The rack-shipment system further may include a top foam panel disposed on a side of the rack. The top foam panel may be configured to protect the rack. The rack-shipment system further may include a bottom foam panel disposed on a side of the rack. The bottom foam panel may be configured to protect the rack. The rack may be positioned horizontally on the pallet, with the ramp being coupled to a bottom of the rack. The ramp may be releasably secured to casters provided on the bottom of the rack. The ramp may be releasably secured to the bottom of the rack by at least one bracket. The ramp may include at least one inclined surface to enable the rack to be removed from the ramp when the rack is in the upright position. The handle may be extendable from a stowed position to an extended position. The ramp may be hingedly coupled to the pallet by at least one hinge.

Yet another aspect of the present disclosure is directed to a method of shipping a rack. In one embodiment, the method comprises: positioning a rack on a pallet; coupling a ramp to the rack, the ramp being hingedly coupled to the pallet; and enclosing the rack for shipment.

Embodiments of the method further may include coupling a handle to the rack. The handle may be configured to rotate the rack and the ramp with respect to the pallet to an upright position. The handle may be extendable from a stowed position to an extended position. The ramp may include at least one inclined surface to enable the rack to be removed from the ramp when the rack is in an upright position. Enclosing the rack may include installing a cover configured to be operably coupled to the pallet. The method further may include disposing at least one of a top foam panel on a first side of the rack and a bottom foam panel on a second side of the rack. The rack may be positioned horizontally on the pallet, with the ramp being coupled to a bottom of the rack. Coupling the ramp to the rack may include releasably securing the ramp to casters provided on the bottom of the rack. Coupling the ramp to the rack may include releasably securing the ramp to the bottom of the rack by at least one bracket. The ramp may be hingedly coupled to the pallet by at least one hinge. The method further may include removing the rack from the pallet. Removing the rack from the pallet may include extending a handle coupled to the rack and moving the handle to rotate the ramp and the rack with respect to the pallet to an upright position. Removing the rack from the pallet further may include de-coupling the rack from the ramp and moving the rack off the ramp.

Another aspect of the present disclosure is directed to a rack-shipment system comprising a support assembly configured to support a rack in a first position for shipping and to present the rack in a second position for removal and a device coupled to the support assembly. The device is configured to move the support assembly to the second position. The support assembly may include a pallet and a ramp hingedly coupled to the base and configured to move with respect to the base from the first position to the second position, the rack being releasably coupled to the base. The rack-shipment system further may include a cover operably coupled to the pallet to enclose the rack. The rack-shipment system further may include a top foam panel disposed on a side of the rack. The top foam panel may be configured to protect the rack. The rack-shipment system further may include a bottom foam panel disposed on a side of the rack. The bottom foam panel may be configured to protect the rack. The rack may be positioned horizontally on the pallet, with the ramp being coupled to a bottom of the rack. The ramp may be releasably secured to casters provided on the bottom of the rack. The ramp may be releasably secured to the bottom of the rack by at least one bracket. The ramp may include at least one inclined surface to enable the rack to be removed from the ramp when the rack is in the second position. The device may be releasably secured to the rack.

### BRIEF DESCRIPTION OF THE DRAWINGS

The accompanying drawings are not intended to be drawn to scale. In the drawings, each identical or nearly identical component that is illustrated with various figures, is represented by a line numeral. For purposes of clarity, not every component may be labeled in every drawing. In the drawings:

FIG. 1 is a top perspective view of a rack-shipment system of an embodiment of the present disclosure;

FIG. 2 is a bottom perspective view of the rack-shipment system;

FIG. 3 is an exploded perspective view of the rack-shipment system containing an IT equipment rack;

FIG. 4 is a perspective view of a pallet with rotating ramp of the rack-shipment system;

FIG. 5 is a perspective view of a top foam panel of the rack-shipment system;

FIG. 6 is a perspective view of a bottom foam panel of the rack-shipment system;

FIG. 7 is a perspective view of the IT equipment rack having a trolly handle;

FIG. 8 is a view of the trolly handle in an extended position;

FIG. 9 is a perspective view of the rack-shipment system with a cover removed;

FIG. 10 is a side view of the rack-shipment system with the trolly handle shown in the extended position;

FIGS. 11 and 12 are perspective and side views showing the IT equipment rack being rotated on the rack-shipment system to a 30 degree angle;

FIGS. 13 and 14 are perspective and side views showing the IT equipment rack being rotated on the rack-shipment system to a 60 degree angle;

FIG. 15 is a perspective view of the IT equipment rack being further rotated on the rack-shipment system;

FIG. 16 is a perspective view of the IT equipment rack fully rotated;

FIG. 17 is a perspective view of a rack-shipment system of another embodiment of the present disclosure with a cover removed, the rack-shipment system supporting an IT equipment rack;

FIG. 18 is perspective view of the rack-shipment system shown in FIG. 17 with the IT equipment rack removed and a rotating ramp rotated to a horizontal position;

FIG. 19 is an enlarged perspective view of a portion of the rotating ramp shown in FIG. 18; and

FIG. 20 is a side view of the rack-shipment system shown in FIG. 17 with a trolly handle shown in the extended position.

### DETAILED DESCRIPTION OF THE DISCLOSURE

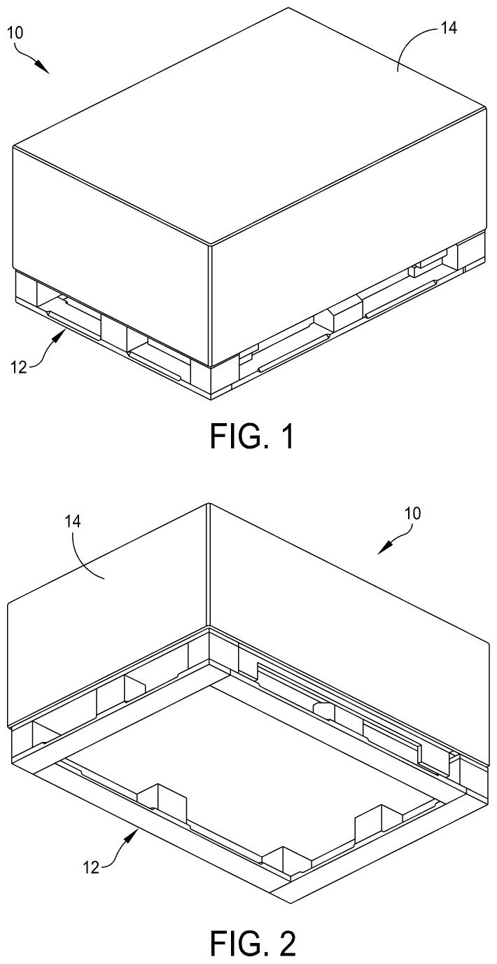

Referring to the drawings, and more particularly to FIGS. 1 and 2, a rack-shipment system is generally indicated at 10. As shown, the rack-shipment system 10 is in a fully enclosed configuration that is capable of supporting electronic equipment. In the shown embodiment, the rack-shipment system 10 includes a pallet, generally indicated at 12, capable of supporting products requiring shipping. As is known, a pallet, which is sometimes called a skid, is a relatively flat transport structure configured to support products and goods in a stable position. Often, the pallet further is configured to be lifted by a forklift, a pallet jack, a front loader, a jacking device or some other lifting apparatus. A pallet provides the structural foundation of supporting a load. For example, goods in shipping containers are often placed on the pallet and secured by suitable materials, such as strapping and/or shrink wrap. Pallets are often fabricated from wood, but can also be made of plastic, metal, paper, corrugated paper and other types of materials, including recycled materials. When unpacking the equipment rack from the pallet, it can be difficult for a single person to remove the equipment rack from the pallet and to orient the equipment rack in an upright position.

In some embodiments, although a pallet is described and shown herein, any other suitable base can be provided to perform the function of pallet 12. For example, a base having a flat, upper surface sized to perform the function of pallet 12 can be employed, e.g., electronic equipment. The base can be configured to be moved or otherwise manipulated to move. In one specific example, the base include rollers or casters that enable the base to move along a horizontal surface. The rollers or casters can be configured to lock to make sure that the base does not move with respect to the horizontal surface.

The rack-shipment system 10 further includes a cover 14 configured to enclose the electronic equipment being supported on the pallet 12. As shown, the pallet 12 includes an outer periphery, which can be selected as described below to secure the product being shipped in the rack-shipment system. The outer periphery of the pallet 12 generally corresponds to an outer periphery of an open end of the cover 14. Thus, when securing the cover 14 to the pallet 12, the edges of the outer periphery of the cover engage the outer periphery or edges of the pallet to provide an enclosed structure. The details of the pallet 12 and the cover 14 will be described in greater detail below.

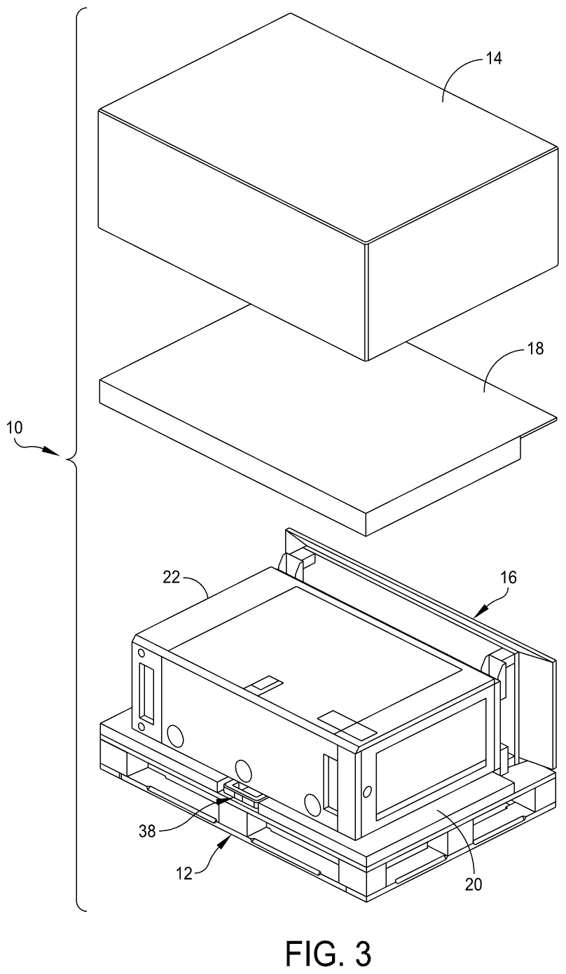

Referring to FIG. 3, in addition to the pallet 12 and the cover 14, the rack-shipment system 10 further includes a rotating ramp, generally indicated at 16, hingedly connected to the pallet 12, a top foam panel 18, and a bottom foam panel 20. As shown, pre-installed IT equipment (ITE) within an IT equipment rack 22 is installed horizontally on the pallet 12, with the rotating ramp 16 being coupled to a bottom of the IT equipment rack. The rotating ramp 16, which is sometimes referred to as a ramp, extends generally vertically with respect to the generally horizontal IT equipment rack 22. In one embodiment, the rack-shipment system 10 is configured to package and ship the IT equipment rack 22 in a horizontal position and to install the IT equipment rack 22 in a vertical position. Stated another way, the IT equipment rack 22 spans from one end to an opposite end of the rack-shipment system 10 when the rack is installed in its final position. As noted above, the IT equipment rack 22 oftentimes cannot be shipped in a vertical position due to mechanical stress applied to the IT equipment rack during shipment or for other reasons. Thus, the IT equipment rack 22 may be shipped in a horizontal position.

When the rack-shipment system 10 is in its assembled condition, the top foam panel 18 is disposed between an upwardly facing surface of the IT equipment rack 22 and a downwardly facing surface of the cover 14. The bottom foam panel 20 is disposed between an upwardly facing surface of the pallet 12 and the downwardly facing surface (side) of the IT equipment rack 22. The top foam panel 18 and the bottom foam panel 20 are provided to protect the IT equipment rack 22 during shipping.

As shown, the rotating ramp 16 is angled generally perpendicularly with respect to the pallet 12 during shipping so that a planar surface of the rotating ramp 16 is generally co-planar with a bottom surface of the IT equipment rack 22. The rotating ramp 16 is configured to be secured to a bottom of the IT equipment rack 22 to secure the IT equipment rack 22 in place. In one embodiment, as will be described in greater detail below, brackets are provided to secure casters provided at the bottom of the IT equipment rack 22 to the rotating ramp 16. The brackets are removed to unsecure the IT equipment rack 22 from the rotating ramp 16 after unpacking the IT equipment rack 22.

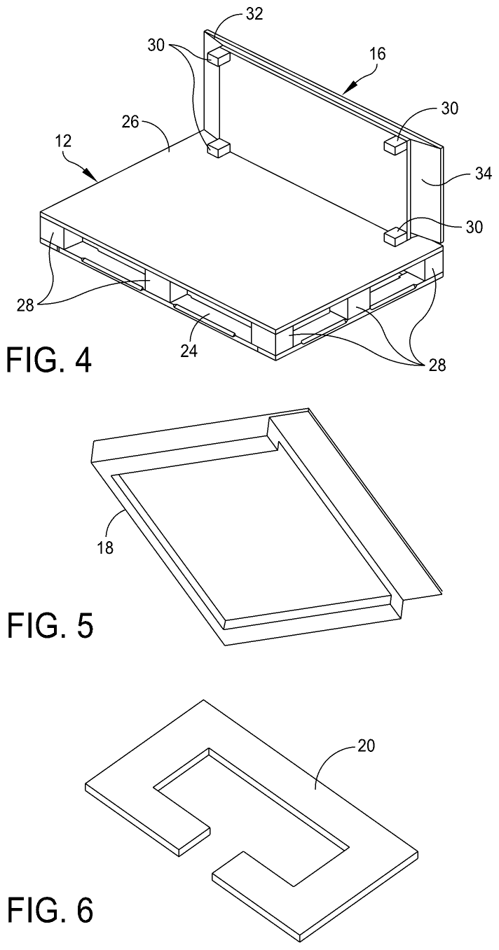

Referring to FIG. 4, the pallet 12 includes a generally rectangular frame structure having a bottom frame portion 24, a top frame portion 26, and several spacers, each indicated at 28, disposed between the bottom frame portion 24 and the top frame portion 26. As shown best in FIG. 2, the bottom frame portion 24 includes an open center, with the spacers 28 secured to the upwardly facing surface of the bottom frame portion 24. In one embodiment, four spacers 28 are provided at the four corners of the bottom frame portion 24, and four spacers 28 are provided at midpoints between the corners. Although eight spacers 28 are provided, any number of spacers can be used to create the space required between the bottom frame portion 24 and the top frame portion 26. The top frame portion 26 is secured to the spacers 28, with a downwardly facing surface of the top frame portion 26 engaging the spacers 28. As mentioned above, the space between the bottom frame portion 24 and the top frame portion 26 as defined by the spacers 28 is used to enable a lifting apparatus, e.g., a forklift, to lift and otherwise move the rack-shipment system 10. The pallet 12 can be fabricated from any suitable material, preferably wood or wood composite material.

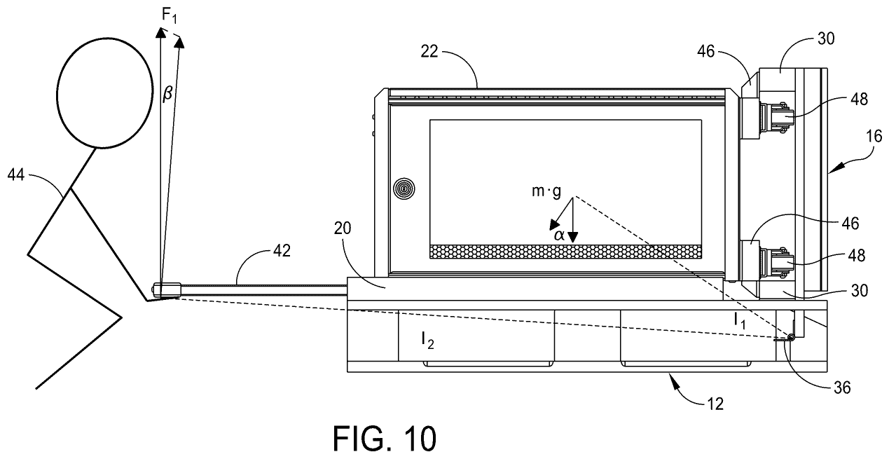

The rotating ramp 16 includes a planar frame structure having a length that generally corresponds to a length of the pallet 12. The width of the rotating ramp 16 is relatively narrow, corresponding to a width of the bottom of the IT equipment rack 22 when secured to the IT equipment rack 22. The rotating ramp 16 includes four blocks, each indicated at 30, which are positioned adjacent to the corners of the rotating ramp 16. The purpose of the blocks 30 is to secure brackets used to secure the IT equipment rack 22 to the rotating ramp 16. The rotating ramp 16 further includes ends 32, 34, which are inclined to enable the IT equipment rack 22, when in its upright position, to move off the rotating ramp 16. In FIG. 4, the pallet 12 and the rotating ramp 16 are shown with the rotating ramp 16 in an upright position in which the rotating ramp 16 is generally perpendicular to the pallet. The rotating ramp 16 is hingedly connected to an edge of the pallet 12 by one or more hinges 36, which are shown in FIGS. 10, 12 and 14. The number of hinges 36 provided depends on the size of the pallet 12 and the rotating ramp 16. In addition to securing the rotating ramp 16 to the pallet 12, the hinges 36 enable the relative rotation of the rotating ramp 16 with respect to the pallet 12.

In some embodiments, the rotating ramp 16 can embody any suitable support. For example, the support structure of the rotating ramp 16 can be fabricated from plywood material, with the blocks 30 being secured to the support structure by fasteners, such as screw fasteners. The ends 32, 34 of the support structure of the rotating ramp 16 can be machined to create the inclined surfaces. The width of the rotating ramp 16 can be selected based on a width of the IT equipment rack 22.

Referring to FIG. 5, the top foam panel 18 is shown to be contoured to protect the IT equipment rack 22 when packaged. The top foam panel 18 is positioned on a side of the IT equipment rack 22 that faces upwardly during shipping. As mentioned above, the top foam panel 18 is disposed between the upwardly facing surface of the IT equipment rack 22 and the downwardly facing surface of the cover 14. In one embodiment, the top foam panel 18 may include a planar foam structure that faces the downwardly facing surface of the cover 14 and downwardly extending edge portions sized to fit around the side of the IT equipment rack 22 that faces upwardly during shipping.

Referring to FIG. 6, the bottom foam panel 20 is shown to be shaped to protect the IT equipment rack 22 when packaged. The bottom foam panel 20 is positioned on a side of the IT equipment rack 22 that faces downwardly during shipping. As mentioned above, the bottom foam panel 20 is disposed between the upwardly facing surface of the pallet 12 and the downwardly facing surface of the IT equipment rack 22.

The top foam panel 18 and the bottom foam panel 20 are designed to hold the IT equipment rack 22 securely in place when assembled within the rack-shipment system 10. The cover 14 can be firmly secured to the pallet 12 as by staples or suitable fasteners or nails.

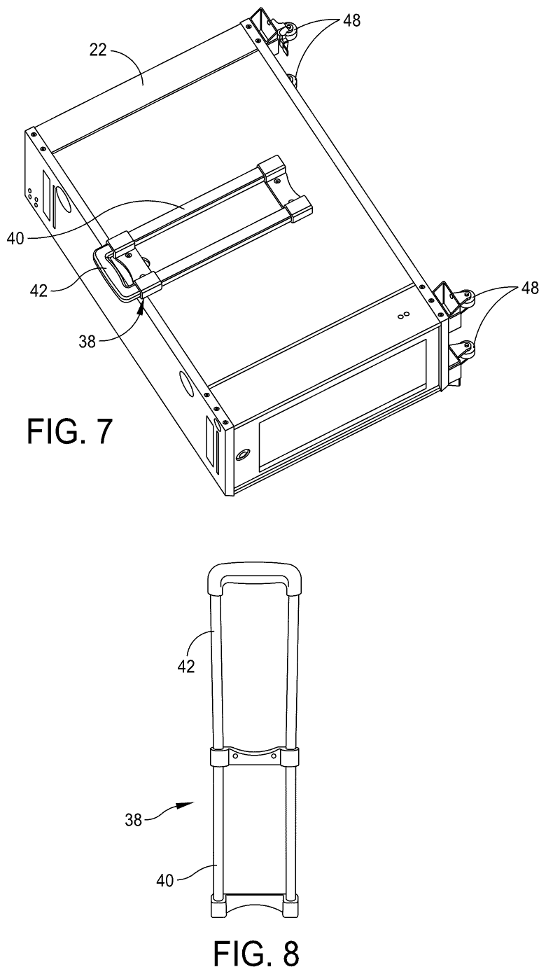

Referring to FIG. 7, the IT equipment rack 22 includes a trolly handle, generally indicated at 38, secured to a side of the IT equipment rack. As used herein, the trolley handle 38 is sometimes referred to as a handle. As shown, the handle 38 includes a frame portion 40 and a handle portion 42, which telescopically extends from the frame portion 40. The frame portion 40 is secured to the side of the IT equipment rack 22 by suitable fasteners, such as machine screw fasteners, which are threadably received within openings formed in the side of the IT equipment rack 22. When the IT equipment rack 22 is positioned on the pallet 12, the handle 38 is on the side of the IT equipment rack 22 facing the bottom foam panel 20. The arrangement is such that an operator can extend the handle portion 42 by pulling on the handle portion 42. FIG. 8 shows the handle 38 in the extended position. Although a trolly handle is shown and described herein, it should be understood that any type of implement capable of being extended can be used to lift and rotate the IT equipment rack 22 to its upright position may be used. For example, an extendable lever arm secured to the IT equipment rack 22 can be provided to manipulate the IT equipment rack 22 as described herein.

In some embodiments, the handle 38 and/or a lever arm can be secured to the IT equipment rack 22 after removing the cover 14 from the pallet 12. The handle 38 and/or a lever arm can be secured to the IT equipment rack 22 with suitable fasteners, with the IT equipment rack 22 having predrilled openings provided to threadably receive the fasteners.

In one embodiment, the rack-shipment system 10 is assembled for shipping as follows. The pallet 12 is placed on a suitable horizontal surface. The fully assembled IT equipment rack 22 is placed on the upper surface of the top frame portion 26 of the pallet 12 on a side of the IT equipment rack 22. The handle 38 can be secured to the IT equipment 22 to the side of the IT equipment rack at this point or prior to placing the IT equipment rack 22 on the upper surface of the top frame portion 26 of the pallet 12. In this position, the casters of the IT equipment rack 22 are proximate to the rotating ramp 16. The IT equipment rack 22 is secured to the rotating ramp 16 by brackets associated with the rotating ramp 16 and configured to be releasably secured to the casters of the IT equipment rack 22. Once secured, the cover 14 is positioned onto the pallet 12 to enclose the IT equipment rack 22, and as described above, can be secured to the pallet 12 as by staples or suitable fasteners or nails.

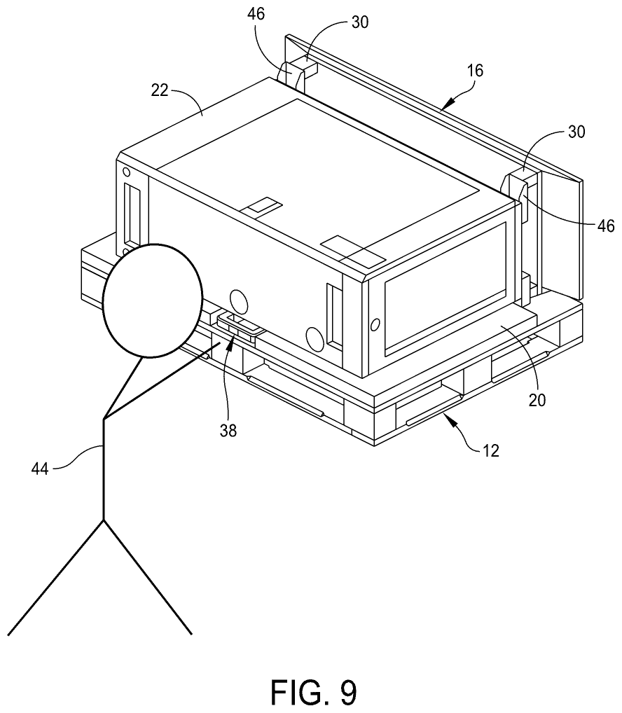

Referring to FIGS. 9-16, a sequence of unpacking the rack-shipment system 10 is shown and described below. FIG. 9 illustrates the rack-shipment system 10 with the cover 14 and the top foam panel 18 removed. An operator can remove the cover 14 from the pallet 12 and remove the top foam panel 18 to reveal the IT equipment rack 22 resting on the bottom foam panel 20 and the pallet 12, sometimes referred to as a first position, with the rotating ramp 16 being secured to the bottom of the IT equipment rack 22. As shown, the pallet 12 of the rack-shipment system 10 is resting on a horizontal surface, e.g., a floor. An operator 44 is reaching for the handle portion 42 of the handle 38.

FIG. 10 illustrates the operator 44 extending the handle portion 42 of the handle 38 with respect to the frame portion 40. As shown, once extended, the operator 44 can raise the handle portion 42 to rotate the IT equipment rack 22 and the rotating ramp 16 about the hinge or hinges 36, which connects the rotating ramp 16 to the pallet 12. In one embodiment, the hinges 36 are mounted to the pallet 12 between the bottom frame portion 24 and the top frame portion 26, which equates to roughly a thickness of the rotating ramp 16. Hands of the operator 44 are positioned under the handle portion 42 of the handle 38 to lift the handle portion and thus rotate the IT equipment rack 22 and the rotating ramp 16 about a pivot point defined by the hinge(s) 36.

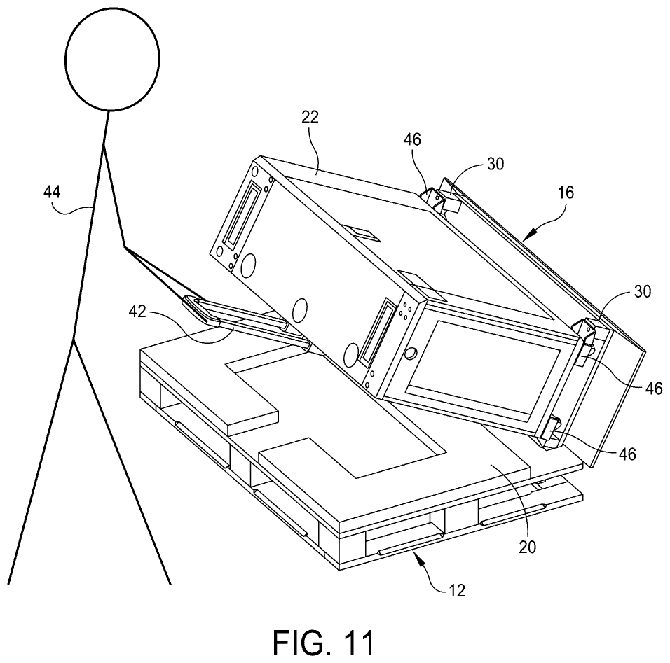

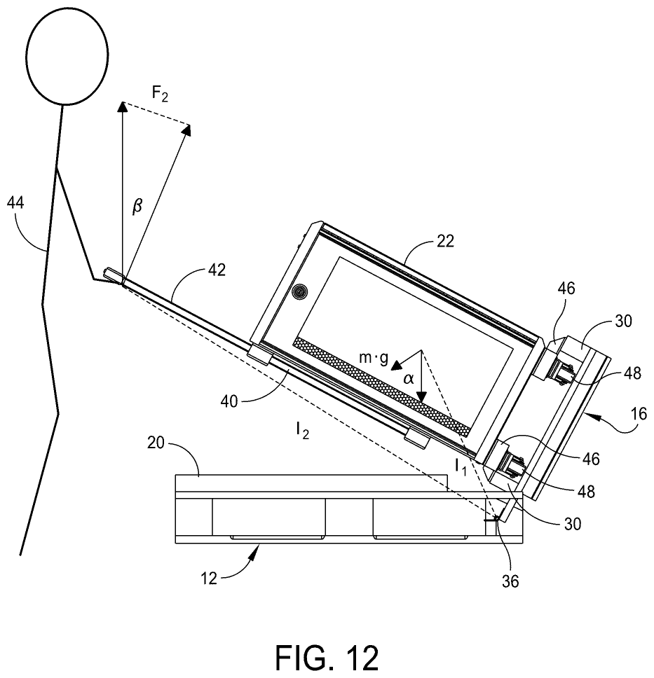

FIGS. 11 and 12 illustrate the operator 44 rotating the IT equipment rack 22 via the trolley handle 38 to a 30 degree angle. As shown, the rotating ramp 16 (and the IT equipment rack 22) rotates with respect to the pallet 12 about the hinge(s) 36. The operator 44 is able to gain a mechanical advantage by virtue of the extendable handle 38. The hinges 36 enable the relative rotation of the rotating ramp 16 with respect to the pallet 12, and serve as a pivot point of this rotation.

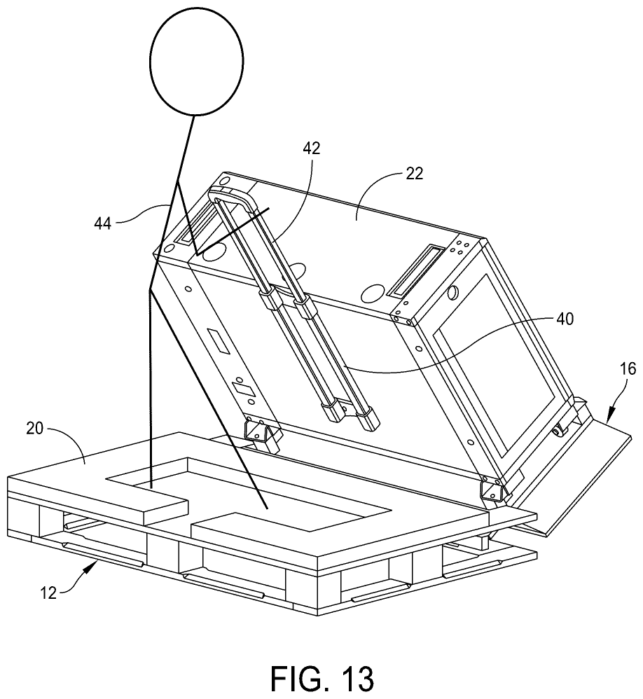

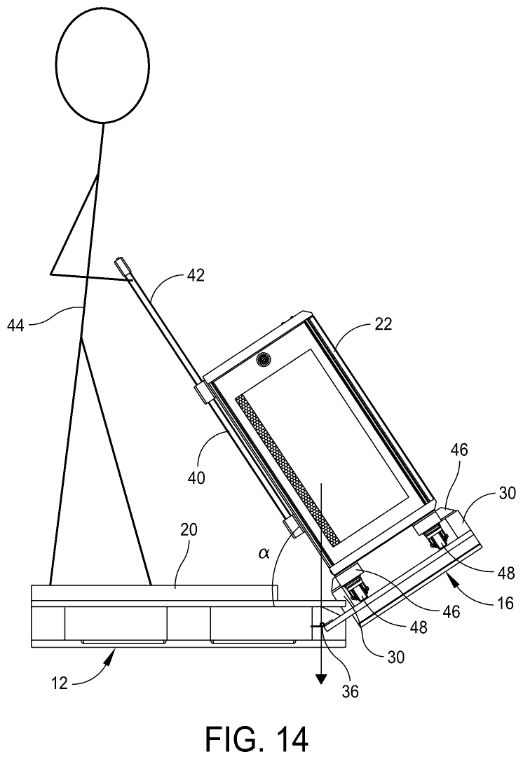

FIGS. 13 and 14 illustrate the operator 44 rotating the IT equipment rack 22 via the trolly handle 38 to a 60 degree angle. As shown, the operator 44 is able to stand on the pallet 12 to hold the pallet flat against the horizontal support surface, thereby enabling the operator to complete the full rotation of the IT equipment rack 22 and the rotating ramp 16 to the upright position. By standing on the pallet 12, there is little to no risk that the pallet will move when completing the rotation of the IT equipment rack 22 and the rotating ramp 16.

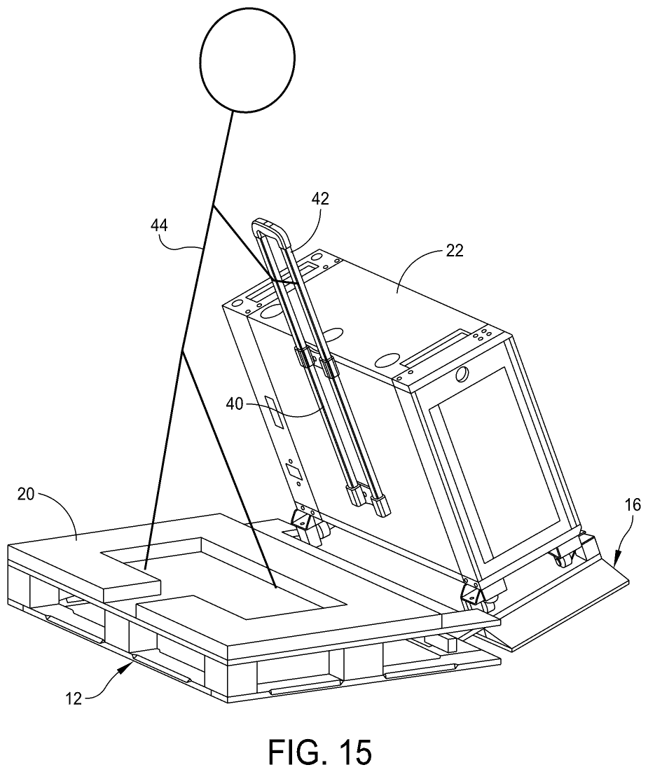

FIG. 15 illustrates the operator 44 further rotating the IT equipment rack 22. As shown, the operator 44 remains standing on the pallet 12, with the rotating ramp 16 being nearly horizontal with respect to the horizontal support surface. Given the weight of the IT equipment rack 22, the operator 44 manipulates the handle 38 to prevent the rotating ramp 16 from forcibly engaging the horizontal support surface by applying a force on the handle 38 in a direction opposite to the force used to initially rotate the IT equipment rack 22 and the ramp 16.

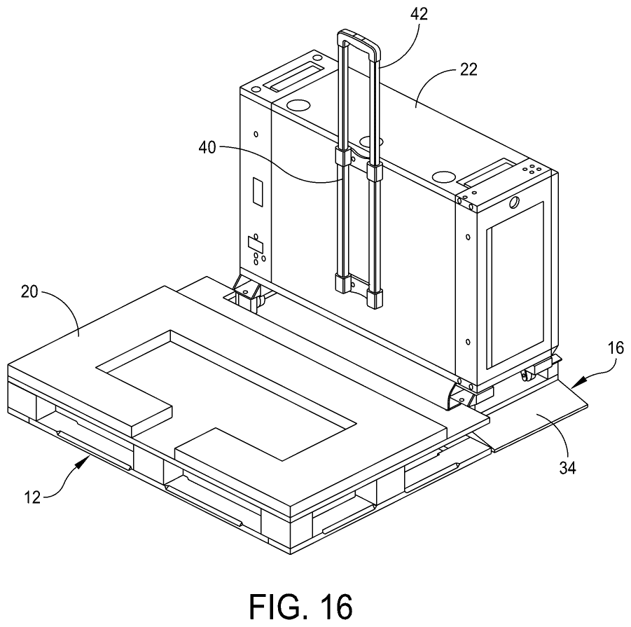

FIG. 16 illustrates the IT equipment rack 22 fully rotated in an upright position, sometimes referred to as a second position. In one embodiment, each block 30 of the rotating ramp 16 includes a bracket 46, which is releasably secured to a respective caster 48 provided on the bottom of the IT equipment rack 22. The brackets 46 are used to secure the IT equipment rack 22 within the rack-shipment system 10 during transport. The brackets 46 are removed from their respective casters 48 to release the rotating ramp 16 from the IT equipment rack 22, thus freeing the IT equipment rack 22 from the rotating ramp 16 of the rack-shipment system 10. Once unpacked, the IT equipment rack 22 can be removed from the rotating ramp 16 to a desired location. The IT equipment rack 22 can be rolled off of the rotating ramp 16 by moving the IT equipment rack on the casters 48 off one of the inclined ends 32, 34 to the desired location. Either prior to or after positioning the IT equipment rack 22, the handle 38 can be removed from the side of the IT equipment rack 22 by unscrewing the fasteners to remove the frame portion 40 of the handle 38.

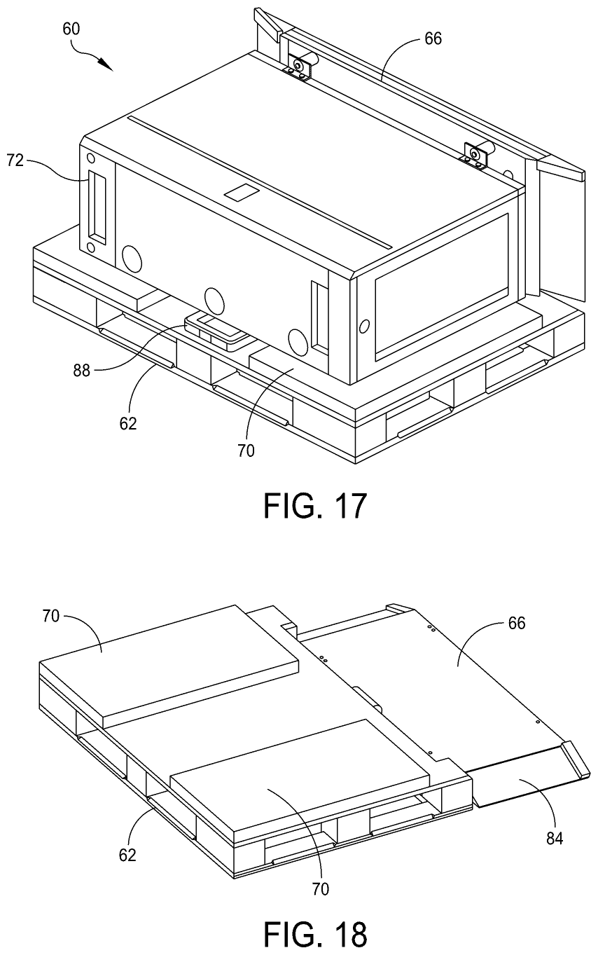

Referring to FIG. 17, in another embodiment, a rack-shipment system of another embodiment of the disclosure is generally indicated at 60. As shown, as with the rack-shipment system 10, the rack-shipment system 60 includes a pallet 62 configured to support an IT equipment rack 72, a rotating ramp 66 hingedly connected to the pallet, and a bottom foam panel 70. It should be noted that the rack-shipment system 60 further includes a cover and a top foam panel, which are removed to view the remaining components of the rack-shipment system 60 more clearly. As shown, pre-installed IT equipment (ITE) within the IT equipment rack 72 is installed horizontally on the pallet 62, with the rotating ramp 66 being coupled to a bottom of the IT equipment rack 72 in a manner described below. As with rack-shipment system 10, the rack-shipment system 60 is configured to package and ship the IT equipment rack 72 in a horizontal position and to install the IT equipment rack 72 in a vertical position.

The bottom foam panel 70 is disposed between an upwardly facing surface of the pallet 62 and the downwardly facing surface (side) of the IT equipment rack 72. Although not shown, the top foam panel is disposed between an upwardly facing surface of the IT equipment rack 72 and a downwardly facing surface of the cover. The top foam panel and the bottom foam panel are provided to protect the IT equipment rack 72 during shipping.

As shown, the rotating ramp 66 is angled generally perpendicularly with respect to the pallet 62 during shipping. The rotating ramp 66 is configured to be secured to a bottom of the IT equipment rack 72 to secure the IT equipment rack 72 in place. In one embodiment, as will be described in greater detail below, brackets are provided to secure the sides of the IT equipment rack 72 to the rotating ramp 66. The brackets are removed to unsecure the IT equipment rack 72 from the rotating ramp 66 after unpacking the IT equipment rack 72.

The construction of the pallet 62 and the rotating ramp 66 of the rack-shipment system 60 are substantially similar to the construction of the pallet 12 and the rotating ramp 16 of rack-shipment system 10. Similarly, the IT equipment rack 72 includes a trolley handle 88 secured to a side of the IT equipment rack.

Referring to FIG. 18, the rotating ramp 66 is pivoted to a horizontal position in which the rotating ramp is co-planar with the pallet 62.

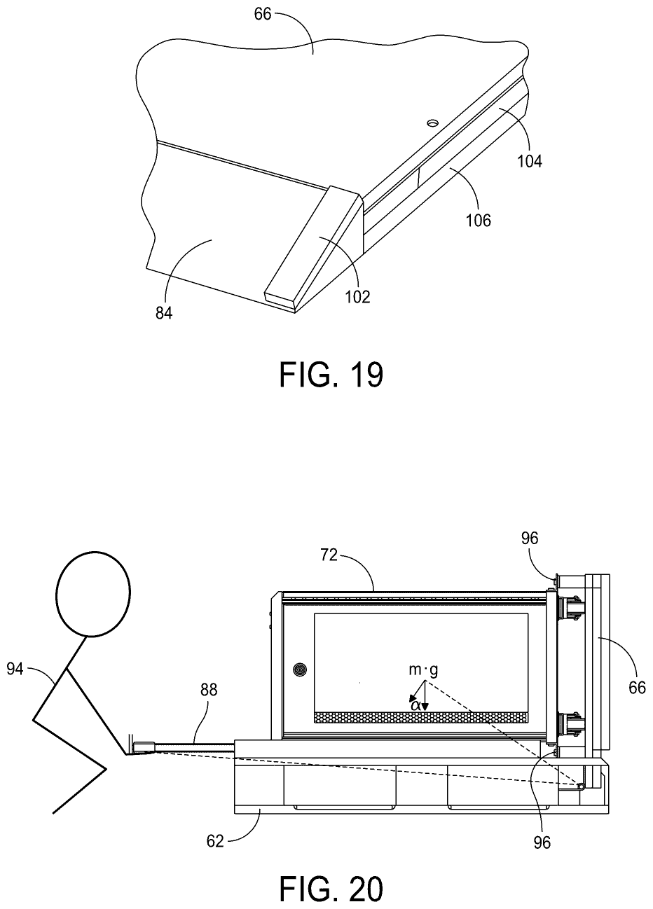

Referring to FIG. 19, details of the rotating ramp 66 are shown. Specifically, the rotating ramp 66 includes a planar (wooden) surface 100, an inclined (wooden) end 84, a (wooden) block 102, a (wooden) middle 104, and a (foam) bottom 106.

Referring to FIG. 20, the handle 88 is extended to enable an operator 94 to pivot the IT equipment rack 72 from the shown horizontal position to an upright vertical position. As shown, the IT equipment rack 72 is secured to the rotating ramp 66 by brackets, each indicated at 96, which are secured to the sides of the IT equipment rack 72 adjacent to the bottom of the IT equipment rack 72.

Thus, it should be observed that the rack-shipment system is capable of shipping the equipment rack with horizontally pre-installed ITE and can be unpacked by a single person. In one embodiment, the lifting weight is approximately 50 lbs maximum. The angle of the handle may be manipulated by the placement of the hinge(s) to decrease the lifting weight.

It should further be observed that one operator can unpack the rack with the pre-installed ITE. The rack and ITE can weigh up to 150 lbs.

Elements of the rack-shipment system include a hinged rotating ramp coupled to the pallet, an extendable trolly handle coupled to the rack, and screw fasteners to couple the equipment rack to the rotating ramp. The screw fasteners are removed to decouple the rack from the rotating ramp when unpacking.

The rack-shipment system of the present disclosure can reduce the cost of electrical component installation projects by reusing structural elements of the system.

Embodiments are not limited in their application to the details of construction and the arrangement of components set forth in the following description or illustrated in the drawings. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the scope of the disclosure. Accordingly, the foregoing description and drawings are by way of example only.

What is claimed is:

1. A rack-shipment system, comprising:
a pallet;
a ramp hingedly coupled to the pallet;
a rack coupled to the ramp; and
a handle coupled to the rack,
wherein the ramp, the rack, and the handle are configured to rotate relative to the pallet to an upright position.

2. The rack-shipment system of claim 1, further comprising a cover operably coupled to the pallet to enclose the rack.

3. The rack-shipment system of claim 1, further comprising a top foam panel disposed on a side of the rack, the top foam panel being configured to protect the rack.

4. The rack-shipment system of claim 1, further comprising a bottom foam panel disposed on a side of the rack, the bottom foam panel being configured to protect the rack.

5. The rack-shipment system of claim 1, wherein the rack is positioned horizontally on the pallet, with the ramp being coupled to a bottom of the rack.

6. The rack-shipment system of claim 5, wherein the ramp is releasably secured to casters provided on the bottom of the rack.

7. The rack-shipment system of claim 5, wherein the ramp is releasably secured to the bottom of the rack by at least one bracket.

8. The rack-shipment system of claim 1, wherein the ramp includes at least one inclined surface to enable the rack to be removed from the ramp when the rack is in the upright position.

9. The rack-shipment system of claim 1, wherein the handle is extendable from a stowed position to an extended position.

10. The rack-shipment system of claim 1, wherein the ramp is hingedly coupled to the pallet by at least one hinge.

11. A method of shipping a rack, the method comprising:
positioning a rack on a pallet;
coupling a ramp to the rack, the ramp being hingedly coupled to the pallet; and
enclosing the rack for shipment.

12. The method of claim 11, further comprising coupling a handle to the rack, the handle being configured to rotate the rack and the ramp with respect to the pallet to an upright position.

13. The method of claim 12, wherein the handle is extendable from a stowed position to an extended position.

14. The method of claim 12, wherein the ramp includes at least one inclined surface to enable the rack to be removed from the ramp when the rack is in an upright position.

15. The method of claim 11, wherein enclosing the rack includes installing a cover configured to be operably coupled to the pallet.

16. The method of claim 11, further comprising disposing at least one of a top foam panel on a first side of the rack and a bottom foam panel on a second side of the rack.

17. The method of claim 11, wherein the rack is positioned horizontally on the pallet, with the ramp being coupled to a bottom of the rack.

18. The method of claim 17, wherein coupling the ramp to the rack includes releasably securing the ramp to casters provided on the bottom of the rack.

19. The method of claim 17, wherein coupling the ramp to the rack includes releasably securing the ramp to the bottom of the rack by at least one bracket.

20. The method of claim 11, wherein the ramp is hingedly coupled to the pallet by at least one hinge.

21. The method of claim 11, further comprising removing the rack from the pallet.

22. The method of claim 21, wherein removing the rack from the pallet includes extending a handle coupled to the rack and moving the handle to rotate the ramp and the rack with respect to the pallet to an upright position.

23. The method of claim 22, wherein removing the rack from the pallet further includes de-coupling the rack from the ramp and moving the rack off the ramp.

24. A rack-shipment system, comprising:
a support assembly configured to support a rack in a first position for shipping and to present the rack in a second position for removal; and
a device coupled to the support assembly, the device being configured to move the support assembly to the second position.
